(19) United States
(12) Patent Application Publication
(10) Pub. No.: US 2002/0191009 A1
(43) Pub. Date: Dec. 19, 2002

(54) Panel driving module

(76) Inventors: Wei-Chen Liang, Hsinchu (TW); Pin Chang, Hsinchu (TW); Heng-Chung Wu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/883,289

(22) Filed: Jun. 19, 2001

(51) Int. Cl. G09G 5/02

(52) U.S. Cl. 345/694

(57) ABSTRACT

The present invention provides a panel driving module, wherein a panel is formed by alternately arranging a plurality of pixels each composed of two sub-pixels. The two sub-pixels are a primary color and its complementary color. The sub-pixels of the primary color and the sub-pixels of its complementary color are alternately arranged. Each row of sub-pixels and each column of sub-pixels are connected together through a signal scan line and a data transmission line, respectively. Every two alternate lines are joined together to form a group and then connected to a driving part. A wire or a conductive spacer is used to connect the two alternate lines in each group. The present invention can decrease the count of semiconductor driving parts used and reduce the cost.

### FIELD OF THE INVENTION

The present invention relates to a display and, more particularly, to an improved panel driving module of a display.

### BACKGROUND OF THE INVENTION

Displays are inevitable equipments of the present information society. They play the roles as output devices for showing pictures and texts. Along with the development of information products toward compactness, flat panel displays become the mainstream of electronic application products gradually. The flat panel displays can be divided into monochromatic type, multi-color type, and full-color type, wherein multi-color displaying effect of the multi-color type display utilizing two complementary colors can meet the requirements of some small portable displays such as personal digital assistant (PDA), mobile phones, digital cameras, video games, and digital watches.

In a color display, the output of its color image is composed of a plurality of pixels on a panel. In a color display utilizing two complementary colors, each pixel is composed of two sub-pixels selected from complementary colors, and magnitudes of voltages are exploited to control the color of each sub-pixel in analog output way, hence forming a color image through different brightness of colors. As shown in FIG. 1, a color filter of a prior art multi-color display utilizing two complementary colors comprises a plurality of sub-pixels selected from complementary colors, wherein sub-pixels 12 of a primary color and sub-pixels 12′ of its complementary color are alternately arranged. In a driving module 10, many data transmission lines 14 and signal scan lines 16 are provided for longitudinally-arranged sub-pixels and transversally-arranged sub-pixels 12 and 12′, respectively. Moreover, each data transmission line 14 and each signal scan line 16 are connected to a data transmission driving part 18 and a signal scan driving part 20, respectively. Thereby, the driving parts 18 and 20 can be used to control whether light can penetrate through each sub-pixel on the color filter, hence forming a multi-color image through different brightness of colors. However, the design of having a driving part for each data transmission line 14 and each signal scan line 16 makes the structure of the panel module complex, the manufacturing process difficult, and the cost high. Moreover, more semiconductor driving parts are required, resulting in a higher cost.

### SUMMARY OF THE INVENTION

The primary object of the present invention is to propose an improved panel driving module structure for simplifying the difficulty of manufacturing panel driving parts and decreasing the count of semiconductor driving parts to reduce the cost.

According to the present invention, a display panel is formed by alternately arranging a plurality of sub-pixels of a primary color and a plurality of sub-pixels of its complementary color. Each row of sub-pixels and each column of sub-pixels are connected together through a signal scan line and a data transmission line, respectively. A plurality of signal scan driving parts and a plurality of data transmission driving parts are provided at the left and right edges and the upper and lower edges of the panel, respectively. Every two alternate lines of the signal scan lines are grouped together and connected in turn left and right to a signal scan driving part. Every two alternate lines of the data transmission lines are grouped together and connected in turn up and down to a data transmission driving part.

The various objects and advantages of the present invention will be more readily understood from the following detailed description when read in conjunction with the appended drawings, in which:

### BRIEF DESCRIPTION OF THE DRAWINGS

FIG. 1 is a diagram of a panel driving module in the prior art;

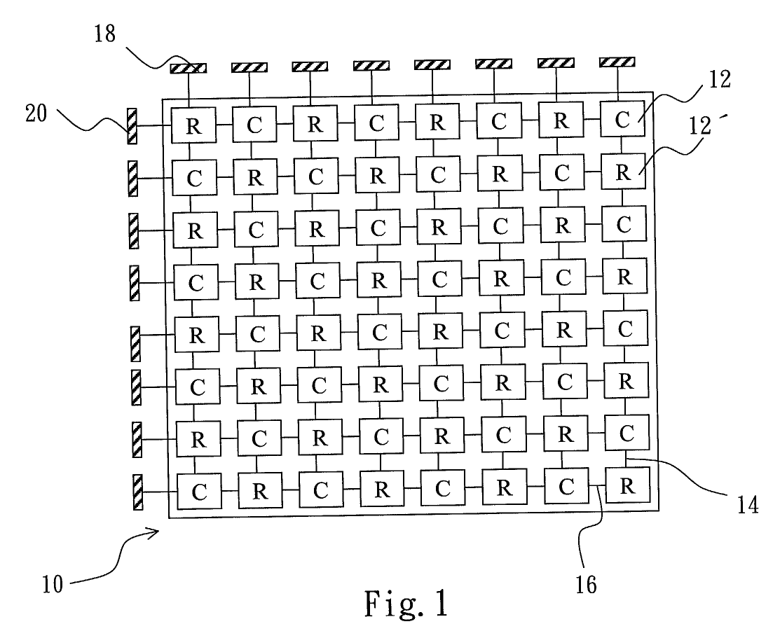

FIG. 2 is a structure diagram of a liquid crystal display;

FIG. 3 is a diagram according to an embodiment of the present invention;

FIG. 4 is a diagram according to another embodiment of the present invention; and

FIG. 5 is a diagram according to yet another embodiment of the present invention.

### DETAILED DESCRIPTION OF THE PREFERRED EMBODIMENTS

The present invention is characterized mainly in that each driving part of the provided panel driving module can simultaneously control two signal scan lines or two data transmission lines to decrease the count of semiconductor driving parts used. The characteristics of the present invention will be illustrated below through a liquid crystal display (LCD).

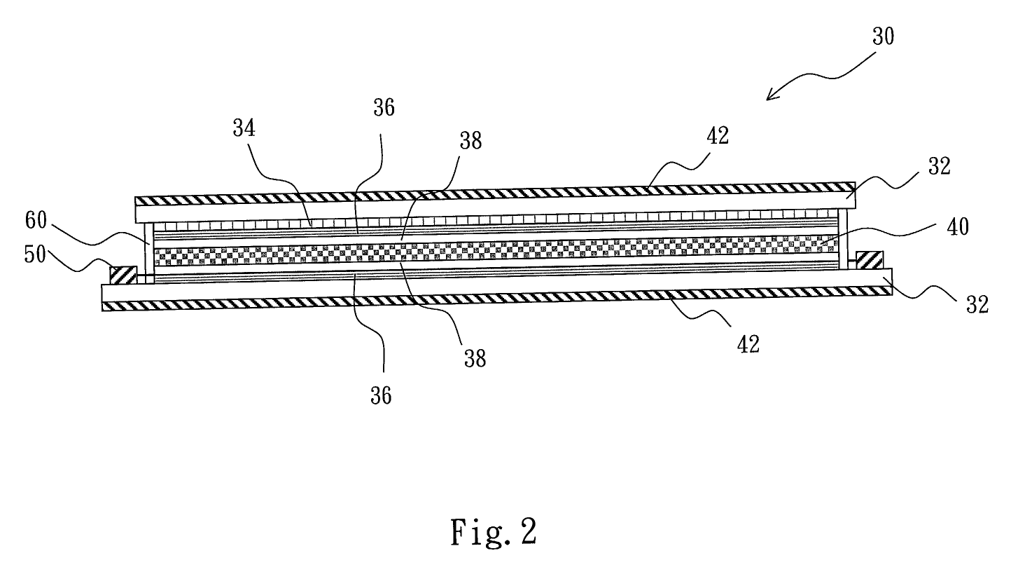

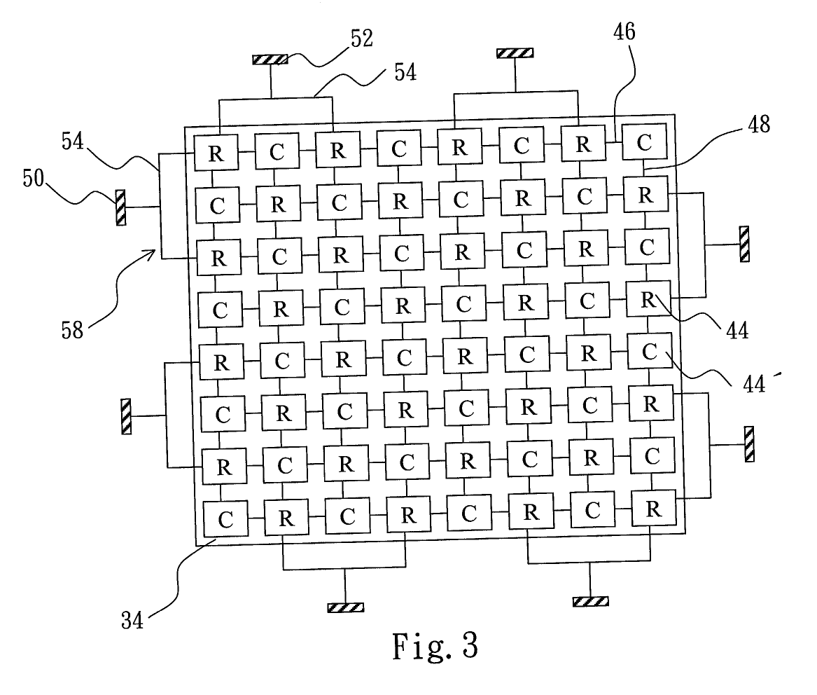

As shown in FIG. 2, a general LCD 30 comprises two transparent substrates 32 and 32′ with a color filter 34, a transparent electrode plate 36, an orientation film 38, a liquid crystal layer 40, an orientation film 38′, and a transparent electrode plate 36′ sandwiched in between from top to bottom in this order. Liquid crystal molecules will rotate and arrange according the direction specified by the orientation films 38 and 38′. A seal-ring 60 is annularly provided at four edges of the two transparent substrates 32 and 32′. Two polarizers 42 and 42′ cover the outer surfaces of the two transparent substrates 32 and 32′, respectively. The color filter 34 is composed of a plurality of sub-pixels 44. The color of each sub-pixel 44 is selected from a primary color and its complementary color. Sub-pixels 44 of the primary color and sub-pixels 44′ of its complementary color are alternately arranged. As shown in FIG. 3, each row of sub-pixels 44 and 44′ and each column of sub-pixels 44 and 44′ are connected through a signal scan line 46 and a data transmission line 48, respectively. Every two alternate lines of the signal scan lines 46 are joined together through a wire 54 to form a group 58 and then connected in turn left and right to a signal scan driving part 50 at the left or right edge of the panel. Every two alternate lines of the data transmission lines 48 are joined together through a wire 54 to form a group 58 and then connected in turn up and down to a data transmission driving part 52 at the upper or lower edge of the panel.

In the present invention, because only a signal scan driving part 50 and a data transmission driving part 52 are needed for driving every two alternate signal scan lines 46 and every two alternate data transmission lines 48, respectively, the count of semiconductor driving parts used can be greatly decreased. In addition to reducing the cost, the characteristic of power saving can also be obtained.

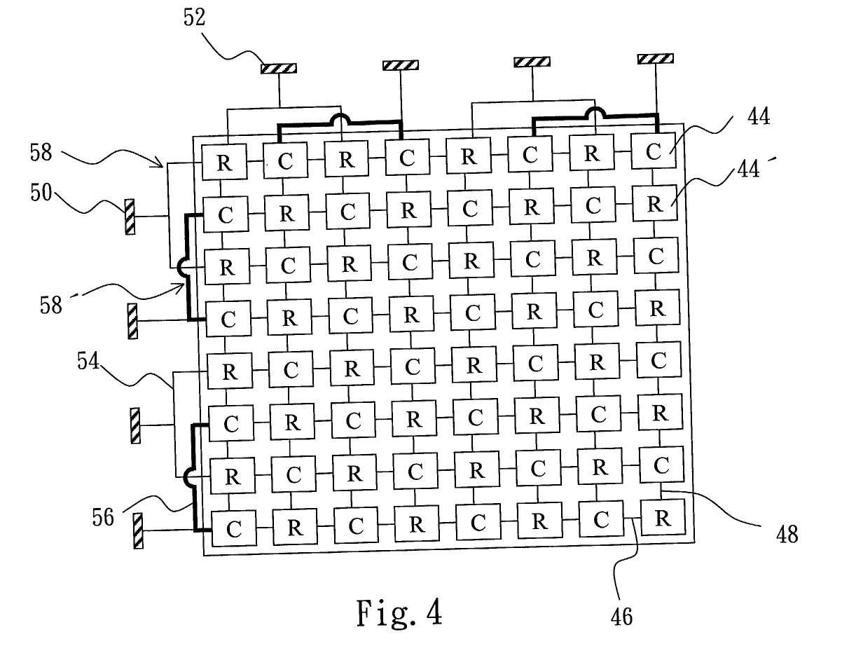

In consideration of limited space for the disposition of the driving parts in general panel driving modules, FIG. 4 shows another embodiment of the present invention. A plurality of signal scan driving parts 50 and a plurality of data transmission driving parts 52 are arranged at two non-parallel edges of the panel. For the driving of the signal scan lines 46, every two alternate lines of the signal scan lines 46 are joined together to form a group 58, and a wire 54 and a conductive spacer 56 are use to connect the two alternate signal scan lines 46 in each group 58 and its adjacent group 58′. This way of using the conductive spacer 56 lets two adjacent groups 58 and 58′ be respectively connected to signal scan driving parts 50 at the same side of the panel. Similarly, for the driving of the data transmission lines 48, every two alternate lines of the data transmission lines 48 are joined together to form a group 58, and a wire 54 and a conductive spacer 56 are use to connect the two alternate data transmission lines 48 in each group 58 and its adjacent group 58′. This way of using the conductive spacer 56 also lets two adjacent groups 58 and 58′ be respectively connected to data transmission driving parts 52 at the same side of the panel. The above conductive spacers 56 for connecting the signal scan lines 46 and the data transmission lines 48 are disposed at the seal-ring 60 of the LCD panel. In addition to decreasing the count of driving parts used, this kind of design of the panel module can also reduce the disposition space of driving parts so that the present invention can apply to modules with driving parts arranged at two edges of their panels.

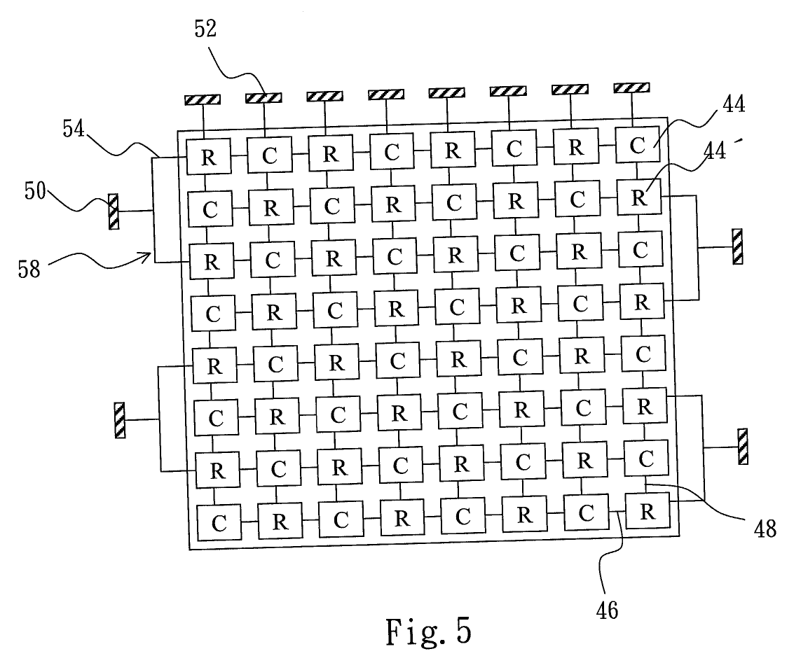

The design of using each driving part to simultaneously control two signal scan lines or two data transmission lines can also apply only to the transversely-arranged signal scan lines 46, as shown in FIG. 5. Each of the data transmission lines 48 is controlled by a driving part as in the prior art. Similarly, each of the signal scan lines 46 can be controlled by a driving part as in the prior art, and every two alternate lines of the data transmission lines 48 are controlled by a driving part.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A panel driving module accomplishing multi-color displaying through controlling brightness and gray-scale contrast of a plurality of sub-pixels on a panel, each row and each column of said sub-pixels being connected together respectively through a signal scan line and a data transmission line, a plurality of driving parts being uniformly arranged at four edges of said panel, every two alternate lines of at least one kind of said signal scan lines and said data transmission lines being joined together to form a group and then connected in turn to one of said driving parts, a wire being used to connect end points of said two lines in each said group.

2. The panel driving module as claimed in claim 1, wherein the color of each said sub-pixel is selected from a primary color and its complementary color, and said sub-pixels of the primary color and said sub-pixels of its complementary color are alternately arranged.

3. The panel driving module as claimed in claim 1, wherein said driving parts of said signal scan lines are uniformly arranged at the left and right edges of said panel to let said wires for connecting said every two alternate signal scan lines be connected in turn left and right to said driving parts.

4. The panel driving module as claimed in claim 1, wherein said driving parts of said data transmission lines are uniformly arranged at the upper and lower edges of said panel to let said wires for connecting said every two alternate data transmission lines be connected in turn up and down to said driving parts.

5. The panel driving module as claimed in claim 1, wherein each said signal scan line can also be controlled by one of said driving parts, and every two alternate lines of said data transmission lines are controlled by one of said driving parts.

6. The panel driving module as claimed in claim 1, wherein each said data transmission line can also be controlled by one of said driving parts, and every two alternate lines of said signal scan lines are controlled by one of said driving parts.

7. A panel driving module accomplishing multi-color displaying through controlling brightness and gray-scale contrast of a plurality of sub-pixels on a panel, each row and each column of said sub-pixels being connected together respectively through a signal scan line and a data transmission line, a plurality of driving parts being uniformly arranged at two adjacent edges of said panel, every two alternate lines of at least one kind of said signal scan lines and said data transmission lines being joined together to form a group and then connected to one of said driving parts, a wire being used to connect end points of said two lines in one group and a conductive spacer being used to connect said two lines of the other group in every two adjacent groups.

8. The panel driving module as claimed in claim 7, wherein the color of each said sub-pixel is selected from a primary color and its complementary color, and said sub-pixels of the primary color and said sub-pixels of its complementary color are alternately arranged.
